(19) United States
(12) Patent Application Publication
(10) Pub. No.: US 2024/0304069 A1
(43) Pub. Date: Sep. 12, 2024

(54) A PORTABLE, HAND-HELD, STANDALONE GUARD DEVICE WITH AN ACTIVE WARNING MEANS

(71) Applicant: LIMITED LIABILITY COMPANY "G-MAK", S. HROMY (UA)

(72) Inventor: Volodymyr Mykolaiovych ROVINSKYI, M. UMAN (UA)

(21) Appl. No.: 18/020,285

(22) PCT Filed: Apr. 4, 2022
(86) PCT No.: PCT/UA2022/000014

§ 371 Date: Feb. 8, 2023

(30) Foreign Application Priority Data
Nov. 3, 2021 (UA) A 2021 06167

(51) Int. Cl. G08B 13/00

(52) U.S. Cl. CPC G08B 13/00

(57) ABSTRACT

The invention is related to the guard devices to be used in rooms, vehicles, public places. The device comprises the motion/movement fixation module, microprocessor module, the communication means, the infrared sensor, the radio-frequency intrusion sensor and the microphone as well as the alarm unit (the lighting warning means, the acoustic warning means, the gas-aerosol warning means). The operation of the device has four main modes being “standby”, “monitoring”, “guarding”, “defense” modes and in an “alarm” state. The device operates automatically in the four main modes being “standby”, “monitoring”, “guarding”, “defense”, as well as in the “alarm” state and provides an individual prompt and convenient control of the active warning means of the device depending on a situation.

### FIELD OF INVENTION

The invention relates to guard devices which are used in various rooms, vehicles, other locations in order to: fix intrusions, penetrations or other events (e.g., fire events, smoke contamination, destruction of windows, doors etc.); remotely transmit, to the device users, signals, messages regarding the intrusion or regarding the events within the room; to generate alarm signals and precautionary alerts regarding unknown individuals who have penetrated into the room in an unauthorized way. The invention is a portable, hand-held, standalone guard device with an active warning means.

### BACKGROUND

A security system with a portable wireless monitor is known, the system comprises the portable wireless monitor and a display, a control panel, security sensors (intrusion sensors or motion sensors), video cameras, a wireless radio transmitter or a video receiver, and at least one portable video monitor/display that comprises a wireless radio-frequency video receiver or transceiver, and a display in the portable housing. The portable monitor may be held by the user manually and carry it conveniently, or it may be mounted and used in a car, e.g., on a dashboard of the car. This security system with the portable wireless monitor/display is intended provide a remote surveillance for a residential or a commercial room (USA invention patent No. U.S. Pat. No. 7,394,359 B2, IPC G08B 1/08, G04Q 7/00, publ. on 1 Jul. 2008 [1]). However, this system completely lacks any active warning means, and, thus, when this system is used, there is no possibility to warn offenders by means of acoustic and/or lighting, and/or gas active warning means.

A portable security system is known, the system comprises a sensor unit, wherein, when the sensor unit detects a motion, it will transmit a motion signal; an alarm device, wherein the alarm device will be activated to provide an alarm signal upon receipt of the motion signal from a sensor (US invention patent application No. US 2010/0019902 A1, IPC G08B 13/08, publ. on 28 Jan. 2010 [2]). A main element and property of the present invention is “a portability”. That is, the invention defines that it is a system that is rapidly and easily transferable from one structure to another one, and that does not lead to a damage of the structure both during mounting and during dismounting. The sensor unit and the alarm of this invention are compact and transportable, as well as they are easily connectible and removable during mounting and dismounting. This invention is also intended to “monitor” the room, to detect the motion, and to transmit alarm signals regarding a possible intrusion into the room. However, the described structure comprises no warning means and, thus, it is not able to operate in an active “defense” mode or in an “alarm” state using the active warning means.

A technical solution that is the closest one to the proposed invention is a security alarm system comprising a device that comprises a housing with a front panel, surveillance and event fixation means in a form of an infrared and a radio-frequency intrusion sensor, a motion/movement fixation module with a video camera, the module is mounted on the front panel, a microphone, a starter unit in a form of a power-up button and light-emitting diode indicators, power supply means in a form of a main power and recharging unit and a standalone power supply unit with batteries, communication means in a form of a WiFi module with a WiFi antenna, a GSM module with a GSM antenna, active warning means in a form of a lighting warning means, a low-frequency and a high-frequency alarm (being acoustic warning means), a gas warning means, a wireless reader of cards and ISO/IEC 14443 standards' tags and a wireless keys reading antenna, MOSFET power keys of a system for controlling the active warning means, a microprocessor module with a main memory unit and with a software that is configured to control the operation of the device at least in a “standby” mode and in an “automatic warning mode” through the MOSFET power keys of the system for controlling the active warning means. Wherein the microprocessor module 44 is interconnected to and has channels for exchanging signals, data, information with the starter unit, with the infrared, and with the radio-frequency intrusion sensors, with the wireless reader of cards and ISO/IEC 14443 standards' tags. Also, the microprocessor module by means of the communication means in the form of the WiFi module and the GSM module is interconnected to and has channels for exchanging signals, data, information with an external software that is located in a wide area network and in local area networks (a utility model patent of Ukraine No. 138039, IPC G08B 13/00, publ. on 11 Nov. 2019 [3]). This utility model is intended to be used in a combination with other types of guard devices and to maintain main functions of a mobile phone. Also, this technical solution must increase an efficiency of notifying regarding a break or a theft due to a sequence of guard and notification algorithms that is executed automatically, and a possibility of performing a defense function in an automatic mode. Also, this security alarm system is intended to enable transmitting, to a remote user, a video information in a form of a continuous data stream in real time via a communication network. However, such utility model is not a portable, hand-held, standalone guard device with an active warning means having a structure that is small-sized, convenient, and safe to use in amenity and other rooms, and, thus, this system does not enable an easy, convenient, and safe standalone transporting, mounting, and using the structure in various rooms without “a linkage” to a stationary power source and without a mandatory “linkage” to external independent guard systems. Furthermore, the efficiency of said system is limited only with three operation modes being “guarding”, “defense”, and “alert” modes (without any possible use of “standby”, “monitoring” modes, and without any possible operation of the device in an “alarm” state). The described system does not enable an individual (manual) prompt and convenient controlling, at a distance (remotely), the active warning means of the device depending on a situation, as well as it does not enable selecting the operation modes by the active warning means. Thus, the known security alarm system, during an unauthorized intrusion into a room that is being guarded, does not enable reacting onto events in this room rapidly and effectively, to inform users about this simultaneously, and to execute commands of the users, if necessary.

### A TECHNICAL TASK, A TECHNICAL EFFECT

The technical task of the invention is to create a portable, hand-held, standalone guard device with an active warning means having a structure that is small-sized, convenient, and safe to use in amenity and other rooms, as well as to directly control a surveillance and guard area, and to fix events in the room being guarded, and to activate or to deactivate the active warning means in a quick manner automatically or manually.

The technical effects which are achieved by the invention owing to all the essential features, including novel features, consist in providing:
a possibility of an easy, convenient, and safe standalone transportation, mounting, and use of the structure in various rooms without any “linkage” to a stationary power source and without a mandatory “linkage” to external independent guard systems;
a possibility of a prompt automatic operation of the device in four main modes being “standby”, “monitoring”, “guarding”, “defense” modes, and in an “alarm” state;
a possibility of an individual (manual) prompt and convenient control of the active warning means of the device depending on a situation (a selective switch on/off of the active warning means);
a possibility of an individual (manual) prompt and convenient selection of the operation modes of the active warning means in order to avoid an occurrence of negative reactions of individuals who have penetrated to the room;
as a consequence of all of the above-mentioned, to achieve an increase of the level, quality, and convenience of the room guarding against the unauthorized intrusion and to enable the device to react onto the events in this room quickly and effectively, at the same time, informing the users regarding this, and to execute the user's commands, if necessary.

### SUMMARY

The posed task is resolved by a portable, hand-held, standalone guard device 1 with active warning means that comprises a housing 2 with a front panel 6, surveillance and event fixation means in a form of an infrared 17 and a radio-frequency 18 intrusion sensor, a motion/movement fixation module 12 with a video camera 13, the module is mounted on the front panel 6, a microphone 11, a starter unit 14 in a form of a power-up button 15 and light-emitting diode indicators 16, power supply means in a form of a main power and recharging unit 19 and a standalone power supply unit 20 with batteries 21, communication means in a form of a WiFi module 34 with a WiFi antenna 35, a GSM module 36 with a GSM antenna 37, active warning means in a form of a lighting warning means 28, a low-frequency 26 and a high-frequency 27 alarm (being acoustic warning means), a gas warning means 33, a wireless reader 41 of cards and ISO/IEC 14443 standards' tags and a wireless keys reading antenna 42, MOSFET power keys 59 of a system for controlling the active warning means 26, 27, 28, 33, a microprocessor module 44 with a main memory unit 45 and with a software that is configured to control the operation of the device 1 at least in a “standby” mode and in an “automatic warning mode” through the MOSFET power keys 59 of the system for controlling the active warning means 26, 27, 28, 33. Therewith, the microprocessor module 44 is interconnected to and has channels for exchanging signals, data, information with the starter unit 14, with the infrared 17, and with the radio-frequency 18 intrusion sensors, with the wireless reader 41 of cards and ISO/IEC 14443 standards' tags, and the microprocessor module 44 by means of the communication means in the form of the WiFi module 34 and the GSM module 36 is interconnected to and has channels for exchanging signals, data, information with an external software that is located in a wide area network and in local area networks.

What is novel is that the housing 2 is made in a form of a structural base of the device 1 and comprises a protective envelope 3 with walls 4, a first 8 and a second 9 internal frame elements which are removable form the protective envelope 3 and insertable into the protective envelope 3, a removable rear panel 5 having an internal plane which a main control board with the microprocessor module 44 is secured to, and a removable front panel 6 with a removable protective cap 7. Therewith, the first internal frame element 8 is a base for securing other structural elements, and the second internal frame element 9 is a housing for the gas or an aerosol, or gas-aerosol warning means 33. Furthermore, a display 10 is mounted on the removable front panel 6 so as to be able to display at least a QR-code, operation modes of the device 1, WiFi and GSM signal levels, a software version. Therewith, the infrared 17 and the radio-frequency 18 intrusion sensor and the microphone 11 are also mounted on the removable front panel 6 of the housing 2, and the lower-frequency 26 and the high-frequency 27 alarms are mounted in the first internal frame element 8 of the housing 2. The gas warning means 33 is made as the gas or aerosol, or gas-aerosol warning means in a form of a device comprising a vessel 60 with an aerosol or a gaseous, or a gaseous-aerosol agent or a mixture of agents, a nozzle 55, a shutter 54 for the nozzle 55, a servo drive 61 of the shutter 54, a servo drive 62 of a lever for discharging the vessel 60. The gas warning means 33 in an assembled state is mounted in the second internal frame element 9 that is, in turn, mounted in the first internal frame element 8 of the housing 2. The lighting warning means 28 is made as a module with a light-emitting diode 29 and further comprises a cooling system 30, a mirror cap 31 with an automatic opening device 3. The standalone power supply unit 20 is connected to an electronic digital module 22 with a software that performs functions of controlling processes of standalone powering and short circuit protection being a POWER management system, and functions of controlling a charge/discharge of a separate cell of the battery 21, controlling and cutoff under an extra low voltage, switching on and off a measurement of energy consumption by the standalone power supply unit 20. Therewith, the standalone power supply unit 20 is configured to be recharged by a mains or an automobile power supply device and is arranged inside the housing 2. The device 1 further comprises control sensors in a form of a pressure sensor 23 with an integrated temperature and humidity sensor 24 that is arranged in the housing 2, and an illumination change control sensor 25 that is mounted on the removable front panel 6. Therewith the microprocessor module 44 and its software are configured and set to control the operation of the device 1 in at least four main modes being “standby”, “monitoring”, “guarding”, “defense” modes and in an “alarm” state. The “standby” mode is a passive state mode of the device 1, while the intrusion sensors 17, 18 and the control sensors 23, 24, 25 are switched off, and in this mode, the microprocessor module 44, by means of the software, is configured to “read” a physical state of the device 1, and the software is configured to transmit technical messages and reminder signals to electronic digital user appliances informing that the device 1 is not present in any of the active modes. The “monitoring” mode is an active mode with the event fixation, while the microprocessor module 44, by means of the software, is configured to fix any actuation of the intrusion sensors 17, 18 and control sensors 23, 24, 25, and to record a data regarding events histories, to perform a photofixation, to transmit technical messages to the electronic digital user appliances and to maintain a communication with the electronic digital user appliances. The “guarding” mode is an active mode, while all the intrusion sensors 17, 18 and control sensors 23, 24, 25 are switched on in order to detect intrusions into a room, the events are being fixed, the data regarding the events history is being recorded, and in this mode, the microprocessor module 44, by means of the software, is configured to switch the device 1 to the “alarm” state, to form and to transmit a message regarding the intrusion into the room and regarding the switch of the device 1 into the “alarm” state to the electronic digital user appliances, and in the “guarding” mode, the microprocessor module 44 and its software are configured and set such that they enable users, by means of their own electronic digital appliance, to selectively transmit commands regarding switching on/off the active warning means 26, 27, 28, 33. The “defense” mode is an active mode, while all the intrusion sensors 17, 18 and the control sensors 23, 24, 25 are switched on in order to detect intrusions into the room, the events are being fixed, the data regarding the events history is being recorded, and the device 1 is set and operates according to a “security zone intrusion detection” algorithm that is set by the software of the microprocessor module 44, and in case of actuation of any of the intrusion sensors 17, 18 and/or of the control sensors 23, 24, 25, according to the settings of the software of the microprocessor module 44, the device 1 is configured to switch to the “alarm” state, and the software of the microprocessor module 44 in the “defense” mode is configured and set to automatically forward control signals for activation of the active warning means 26, 27, 28, 33 under a proviso that such permissions for the activation of the active warning means 26, 27, 28, 33 are switched on by the user in advance in the settings of the software of the microprocessor module 44, wherein the settings of the software of the microprocessor module 44 for the “defense” mode are also configured to enable the users to switch on/off any of the active warning means 26, 27, 28, 33 by transmitting signals from the electronic digital user appliances, furthermore, in the “defense” mode, the motion/movement fixation module 12 with the video camera 13, the microprocessor module 44 and its software are configured and set to perform photofixations, to transmit technical messages to the electronic digital user appliances, and to maintain a constant communication with the electronic digital user appliances. The “alarm” state is an active state, while all the intrusion sensors 17, 18 and the control sensors 23, 24, 25 are switched off, and the device 1, according to the settings of the software of the microprocessor module (44), is configured to switch to the “alarm” state from the “guarding” or “defense” modes as a result of a situation analysis performed by the software of the microprocessor module 44 and from signals of the software of the microprocessor module 44, or due to switching on the “alarm” state by the users by transmitting signals from the electronic digital user appliances, wherein in the “alarm” state that is switched on by the user, the software of the microprocessor module 44 is set to form and to transmit messages regarding switching of the device 1 to the “alarm” state to the electronic digital user appliances, furthermore, under a proviso that the settings in the form of permissions for the activation of the active warning means 26, 27, 28, 33 are switched on in advance, the software of the microprocessor module 44 is set to automatically transmit the control signals for the activation of all or selected active warning means 26, 27, 28, 33, furthermore, during the operation process of the device 1 in the “alarm” state, the software of the microprocessor module 44 is set such that it enables the user to switch on or off any of the active warning means 26, 27, 28, 33 individually “manually” and remotely by transmitting the signals from the electronic digital user appliances, and in the “alarm” state, the microprocessor module 44 and its software are configured and set to constantly maintain the communication with the electronic digital user appliances devices. In order to enable the control of the operation of the device 1 in the at least main modes being the “standby”, “monitoring”, “guarding”, “defense” modes and in the “alarm” state, the device 1 comprises two additional microcontrollers 46, 50 each being in a communication with the microprocessor module 44. The first additional microcontroller 46 comprises a module 47 for controlling the lighting warning means 28, a module 48 for controlling the servo drive of the mirror cap 31 of the light-emitting diode 29 of the lighting warning means 28, a module 49 for controlling the low-frequency alarm 26. The second additional microcontroller 50 comprises a module 51 for controlling the servo drive for dissipating the gas or aerosol, or gas-aerosol warning means 33, a module 52 for controlling the servo drive of the protective shutter 54 of the system for dissipating the gas warning means 33, and a module 53 for controlling the high-frequency alarm 27.

For certain individual conditions as well as embodiments and use cases of the inventive structure, the proposed portable, hand-held, standalone guard device with the active warning means is characterized by the following features, which develop, specify the set of features of independent claim.

The device 1 further comprises a signal receiving/transmitting and processing radio-frequency module 39, the signals come from additional remote external active warning means and from optional external wireless sensors 57. The signal receiving/transmitting and processing radio-frequency module 39 is coupled to the microprocessor module 44. Therewith, the additional remote external active warning means are the low-frequency alarm, the high-frequency alarm, the lighting warning means, the gas or aerosol, or gas-aerosol warning means, each of them comprises a corresponding receiving-transmitting module. The optional external wireless sensors 57 are motion, presence, glass breakage, smoke, flood and fire sensors, an electromagnetic door opening sensor, a gas leakage sensor, each of them comprises a corresponding receiving-transmitting module.

The signal receiving/transmitting and processing radio-frequency module 39 is configured to connect and to establish an intercommunication with the external electronic digital user appliances to activate the device 1 in the “alarm” state remotely.

The device 1 further comprises, as the communication means, an ETHERNET communication unit 38 that is coupled to the microprocessor module 44.

The microprocessor module 44 is coupled to the light-emitting diode indicators 16, and the software of the microprocessor module 44 is set to display the change of the operation modes and state of the device 1 on the removable front panel 6 by means of the light-emitting diode indicators 16.

The device 1 comprises a power supply device 56 that is consistent with the QC 1.0, QC 2.0, QC 3.0 charging protocols and is configured to connect to a battery management system 58 for the battery 21 of the standalone power supply unit 20.

### Inventive Step

The implemented structure of the device 1 represents a portable, hand-held, standalone article that is transportable, if necessary, by the user from any location to another any location in order to be used according to the purpose. The device 1 may be mounted and used in various rooms (enclosed spaces) without any mandatory “linkage” to the stationary power source and without any mandatory “linkage” to external independent guard systems. Such properties of the invention are achieved due to the presence of the housing 2 and to originality of the structural features of this housing 2 and its constituent elements (the protective envelope 3, the two internal frame elements 8, 9, the rear 5 and the front 6 face panels) together with all other elements and details of the invention, which are composed and mutually arranged so that all the elements of the invention are mounted in the housing 2 or “are in a structural linkage” to the housing 2 via other details of the housing 2. That is, the structure of the device 1 comprises all constituent details and elements, which are necessary for the effective standalone and independent operation of the device 1, and, due to the original structure of the housing 2 and its elements (FIG. 1), all the constituents of the device 1 are ergonomically and portably arranged in a rather small space that is formed by the housing 2, the protective envelope 3 with the walls 4, the rear 5 and the front 6 face panels. Therewith, the structure of the internal frame elements 8, 9 of the housing 2 is formed such that it enables mounting and fixing the internal frame element 9 (together with the gas or aerosol, or gas-aerosol warning means 33 mounted therein) in the structure of the internal frame element 8, and then arranging and fixing them together within the housing 2 in a compact fashion. Furthermore, the structural features and the configuration of the housing 2, the protective envelope 3, the internal frame elements 8, 9, the rear 5 and the front 6 face removable panels are made such that they may be quickly dismounted in order to enable a convenient and quick replacement, current maintenance, check, or repair of the details of the device 1. The “removability” of the rear panel 5 together with the main electronic control board 43, as well as the main 19 and the standalone 20 power supply units enables the users to gain a quick access to all details of the control board 43 and to the power supply units in order to check, to provide maintenance, to repair, and to simultaneously arrange the electronic control board 43 inside the housing 2, its protection by the walls 4 and by the rear panel 5 do not allow quick affecting the electronic components of the device 1 by intruders. At the moment of the mechanical influence onto the device 1, at least an automatic reaction of tamper sensors (not shown in the drawings) takes place, the tamper sensors may be mounted on a replacement cap of the vessel 60 (for the gas-aerosol warning means 33) and in a region of the rear panel 5, and after any sensor of the device 1 is actuated, due to operation of the software of the microprocessor module 44 and the communication means 34, 35, 38, messages regarding attempts of the mechanical influence onto the device 1 will be transmitted to the users even prior to its possible destruction. In the same way, the “removability” of the front panel 6 and the protective cap 7 of this front panel 6 enable the users to gain a quick access to the structural elements, which are arranged in the region of the front panel 6 (the display 10, the microphone 11, the video camera 13 with the microcontroller 13.1, the power on/off button 15; the infrared intrusion sensor 17, the radio-frequency intrusion sensor 18, the light-emitting diode indicators 16), and the protective cap 7 does not allow quick affecting (physical, mechanical etc.) the electronic and other components of the device 1, which are arranged in the region of the front panel 6. Furthermore, a pad 63 (a PIR window) is further arranged on the removable protective cap 7 in order to provide the additional protection of the infrared intrusion sensor 17 and the video camera 13.

The “standalone” feature of the device 1 is an important property of the whole structure of the present invention. Besides the original configuration of the housing 2 and its elements, the “standalone” feature of the device 1 provides that completely all elements, which provide the effective operation of the invention, are arranged directly within the device 1 or on/in its structural details of the housing 2, including: all the intrusion sensors 17, 18, the control sensors 23, 24, 25, the microphone 11, the video camera 13, all the active warning means 26, 27, 28, 33, the main electronic control board 43 with the microprocessor module 44, with the memory 45, with the additional microcontrollers 46, 50 and with modules 47, 48, 49, 51, 52, 53 for controlling the active warning means 26, 27, 28, 33 and their structural elements, the power sully units 19, 20, the battery 21, the communication means being the WiFi module 34, the GSM module 36, the ETHERNET communication unit 38 (in separate embodiments of the invention). In the most of the known guard systems, usually, control means/sensors, defense/warning means, control, powering, communication elements may be “spaced and separated” in different points in a room to be guarded and they are separate appliances, e.g., a power supply unit made separately with a communication unit, control means (sensors) mounted separately, and defense/warning means arranged separately (e.g., an acoustic alarm and a light alarm). In contrast to similar known guard systems, all the elements of the proposed invention are united in a single structural article which represents the portable, hand-held, standalone guard device with the active warning means. Therefore, the presence and the features of the structure of the housing 2 and its details (3, 4, 5, 6, 7, 8, 9-FIG. 1) in combination with the arrangement and combination of all other structural elements in this housing 2 into the single article make the device 1 “portable” and “standalone” that, in turn, enables easy, convenient, and safe transportation, mounting, and use of the device 1 in various rooms without the “linkage” to the stationary power source and without the mandatory “linkage” to external independent guard systems.

In order the device 1 could operate normally, the main power and recharging unit 19, the standalone power supply unit 20 with the batteries 21 must be charged. The device 1 is activated manually by the power on/off buttons 15 of the starter unit 14. Furthermore, the device 1 comprises the wireless reader of cards and tags 41 (of ISO/IEC 14443 standards, RFID) with the wireless keys reading antenna 42, and the invention provides a possibility of powering on/off the device 1 by means of reading (by the wireless keys reading antenna 42 of the wireless reader of cards and tags 41) of an individual RFID-tag that may be possessed by the user in a form of a card or a breloque with the RFID-tag chip. Also, the users, by means of their own electronic digital appliances, may power off or on the device 1 remotely by transmitting the corresponding signals via the Internet and communication means (e.g., via the WiFi module 34) to the software of the microprocessor module 44.

The novel feature of the invention is that except for the main power and recharging unit 19, the device further comprises the standalone power supply unit 20 with the module 22 (with the software), the batteries 21 and the batteries 21 management system 58. The standalone power supply unit 20 has a function of recharging from the mains or the automobile power supply devices. The batteries 21 maintain the standalone powering of the elements of the device 1. The module 22 and the battery 21 management system 58 (the BMS-system) enable:
to control the processes of the standalone power supply of the unit 20 and to protect against a short circuit (POWER management system);
to control the charge/discharge of each individual cell of the battery 21;
to control a voltage level and to cutoff the device 1 at the extra low voltage;
to turn on and off the measurement of the energy consumption of the standalone power supply unit 20.
The presence 1 of the standalone power supply unit 20 with the module 22 (with the software), the batteries 21, the battery management system 58 and their mutual connection with other elements of the device 1 enable performing a mobile charging of the device 1 at any location where there is an access to the mains or automobile, or another powering device, thereby making the device 1 more “independent”, “standalone”, and, if necessary, “mobile” during the use.

In separate embodiments of the invention, it further comprises the power supply device 56 (FIG. 2) that may be compatible with the charging protocols QC 1.0, QC 2.0, QC 3.0 and is capable of coupling to battery management system 58 for the battery 21 of the standalone power supply unit 20, thereby also providing additional possibilities for charging the device 1.

The microprocessor module 44 together with its software is the main structural element that enables managing the operation of the device 1 and controlling it. The microprocessor module 44 is coupled to other elements of the device 1. The microprocessor module 44 together with its software performs the following actions and functions: receiving, processing, analyzing, systematizing and, if necessary, storing all signals from the motion/movement fixation module 12 (from the sensors 17, 18, microphone 11, video camera 13), from the sensor 23, 24, 25, from the optional (external) wireless sensors 57 (if any); performing the management of the operation and controlling the stationary active warning means 26, 27, 28, 33 and the optional (external) wireless active warning means (if any); forming and transmitting (as well as receiving, processing, analyzing), through the communication means, signals, data, information to the electronic digital user appliances or to other users which are defined by the users. The software of the microprocessor module 44 forms a unique QR-code and “depicts” it on the display 10 for a limited time in order to enable reading this QR-code by the electronic digital user appliances to establish a unique connection to the device 1. The uniqueness of the QR-code depicted on the display 10 and the time limitation of the access thereto enable increasing the security level by limiting the access to the device 1 by unauthorized individuals.

The microprocessor module 44 with the software, the memory unit 45 together with the two additional microcontrollers 46, 50, the modules for controlling the active warning means 47, 48 (the lighting ones), 49, 53 (the acoustic alarms), 51, 52, 54 (the gas or aerosol, or gas-aerosol one), the MOSFET power keys 59 on the field-effect transistors, the low-frequency 26 and the high-frequency alarms, the lighting warning means 27, the gas or aerosol, or gas-aerosol warning means 33, the stationary intrusion and control sensors 17, 18, 23, 24, 25 (in separate embodiments, with optional (external) wireless sensors 57 and with the signal receiving/transmitting and processing radio-frequency module 39 with the antenna 40), and together with the power supply units 19, 20 enable the device 1 to operate in four main operation modes: “standby”, “monitoring”, “guarding”, “defense”, as well as in the “alarm” state of the device 1. Each of said operation modes and the “alarm” state has its own function and, thus, in each of the modes, the device 1 and its elements “react” to events that occur “under the supervision” of the device 1 differently.

Algorithms of the four operation modes and the “alarm” state of the device 1 and its elements are preliminary programmed in a form of source codes of the software of the microprocessor 44, of the two additional microcontrollers 46, 50, and other modules of the device 1. The following are meant under the “algorithms of the four operation modes and the “alarm” state of the device 1″: “transitions” of the device 1 into a certain mode or state, a reaction of the sensors of the device 1 to events in the certain mode or state, receiving and analyzing the signals from the sensors 17, 18, 23, 24, 25 and from the microphone 11 and the video camera 12, actions of the elements of the device 1 in the certain mode or state, transmission/receipt of the signals within the device 1 between its elements and transmission/receipt of the signals externally/from outside through the communication means being a contact with the electronic digital user appliances. The microprocessor module 44 is coupled to the elements of the motion/movement fixation module 12 (with the sensors 17, 18, the microphone 11, the video camera 13) and with the sensors 23, 24, 25 (sometimes, with optional (external) wireless sensors 57) and receives (or does not receive) signals from said elements, wherein the software of the microprocessor module 44 is created and set such that said received signals are recognized, processed, and analyzed according to the software instructions. And then, based on this data, the microprocessor module 44 (according to the software instructions), by means of the two additional microcontrollers 46, 50 and the modules 47, 48, 49, 53, 51, 52, 54 (selectively or simultaneously), the MOSFET power keys 59 provides/transmits the control signals to the active warning means and separate details thereof: to the low-frequency alarm 26, the high-frequency alarm 27, the lighting warning means 28 (the light-emitting diode 29, the cooling system 30, the servo drive 32 for the automatic opening of the mirror cap 31 of the lighting warning means 28), the gas or aerosol, or gas-aerosol warning means 33 (the servo drive 61 of the protective shutter 54 of the nozzle 55 of the vessel 60, the servo drive 62 of the lever for discharging the gas or aerosol, or gas-aerosol agent from the vessel 60). Thus, the microprocessor module 44 is coupled to said active warning means via the two additional microcontrollers 46, 50, via the corresponding modules for controlling the active warning means 47, 48 (the lighting ones), 49, 53 (the acoustic alarms), 51, 52, 54 (the gas or aerosol, or gas-aerosol one), and via the MOSFET power keys 59.

In the “standby” mode, the device 1 is passive, the intrusion sensors 17, 18, and the control sensors 23, 24, 25 are turned off. The microprocessor module 44 automatically, by means of the software, “reads” a power status, a presence, and a power of the communication signals, other parameters of the device 1. The software of the microprocessor module 44 is set such that it transmits the technical messages and reminder signals to the electronic digital user appliances indicating that the device 1 is not in any of the active operation modes “monitoring” or “guarding”, or “defense”, or in the “alarm” state. In the “standby” mode, the software of the microprocessor module 44 is not able to turn on any active warning means.

In the “monitoring” mode, the device 1 is active. The intrusion sensors 17, 18, the control sensors 23, 24, 25, the microphone 11, the video camera 13 are turned on, and any activation of any one of the intrusion sensors 17, 18 and/or control sensors 23, 24, 25 of the motion/movement fixation module 12 (the microphone 11, the video camera 13, the sensors 17, 18). In the “monitoring” mode, according to the algorithm set by the software of the microprocessor module 44, the following occurs: surveillance of the inner space of the room in order to detect the motion or other changes in the room; recording of the data into the memory unit 45 of the microprocessor module 44 regarding the events histories that take place; photofixation and transmission of the messages to the electronic digital user appliances. In the “monitoring” mode, the software of the microprocessor module 44 is not able to turn on any active warning means.

In the “guarding” mode, the device 1 is active. The intrusion sensors 17, 18, the control sensors 23, 24, 25, the microphone 11, the video camera 13 are turned on. In the “guarding” mode, according to the algorithm set by the software of the microprocessor module 44, the following occurs: detection of the intrusion into the room, fixation of the events, recording of the data regarding the events history into the memory unit 45 of the microprocessor module 44; switching (transition) of the device 1 into the “alarm” state; photofixation; transmission of the alarm messages, photos regarding the intrusion into the room to the electronic digital user appliances.

In the “defense” mode, the device 1 is active. The intrusion sensors 17, 18, the control sensors 23, 24, 25, the microphone 11, the video camera 13 are turned on. In the “defense” mode, according to the algorithm set by the software of the microprocessor module 44, the following occurs: switching to the “alarm” state; the same actions as in the “guarding” mode; the software of the microprocessor module 44 automatically transmits the control signals for activation of all or selected active warning means 26, 27, 28, 33; photofixation of the events; transmission of the technical messages to the electronic digital user appliances and maintaining a continuous communication with the electronic digital user appliances.

The device 1 transits to the “alarm” state from the “guarding” mode (manually) and from the “defense” mode (automatically and/or manually). The software of the microprocessor module 44 forms and transmits the messages regarding the intrusion into the room and regarding the switching of the device 1 into the “alarm” state to the electronic digital user appliances. The software of the microprocessor module 44 forms and transmits the control signals for activation of all or a part of the active warning means 26, 27, 28, 33, if such activation permissions are preliminary switched on by the user in the settings of the software of the microprocessor module 44. Furthermore, owing to the settings of the software and the communication means of the WiFi module 34, the GSM module 36 (in separate embodiments, by means of the ETHERNET communication unit 38), the users are allowed to switch on or off any one of the active warning means 26, 27, 28, 33 individually “manually” and remotely by transmitting the signals from their own electronic digital appliances (phones, smartphones, computers, radio signal transmitters, e.g., a portable radio console, etc.).

In separate embodiments of the invention, the microprocessor module 44 may be coupled to the light-emitting diode indicators 16, and the software of the microprocessor module 44 is set such that it enables displaying the change of the operation modes and state of the device 1 on the removable front panel 6 by means of the light-emitting diode indicators 16.

Therefore, depending on the settings of the software of the microprocessor module 44 which are set by the user preliminary and on a situation at a site being guarded, the device 1 operates in one of the four modes being “standby” or “monitoring”, or “guarding”, or “defense”, or in the “alarm” state, and, if necessary, the transition of the device 1 to another mode/state is performed automatically under the “guidance” of the microprocessor module 44. Furthermore, owing to the presence of the WiFi module 34, the GSM module 36 (in separate embodiments, the ETHERNET communication unit 38 as well), their interconnection with the microprocessor module 44 and its software settings, the users, if necessary, are allowed to switch said operation modes of the device 1 remotely and to switch the device into the “alarm” state or to switch off this state. Also, owing to the original structure of the device 1 and the interconnection of its elements and details, the users are allowed to control each of the active warning means 26, 27, 28, 33 individually (manually) in an operational and convenient manner remotely (being the selective switching on/off) depending on the current situation at the site being guarded. Therewith, owing to the presence and originality of the structure and the interconnections between:
the lighting warning means 28 and the light-emitting diode 29, the cooling system 30, the mirror cap 31, the device (the servo drive) 32 for the automatic opening of the mirror cap 31, the module 47 for controlling the lighting warning means 28, the module 48 for controlling the servo drive of the mirror cap 31 of the light-emitting diode 29 of the lighting warning means 28;
the low-frequency alarm 26 and the module 49 for controlling thereof;
the high-frequency alarm 27 and the module 53 for controlling thereof;
the gas or aerosol, or gas-aerosol warning means 33 that is mounted in the second internal frame element 9 with the vessel 60, the nozzle 55, the protective shutter 54 of the nozzle 55, the servo drive 61 of the protective shutter 54, the servo drive 62 of the lever for discharging the gas or aerosol, or gas-aerosol agent, the module 51 for controlling the servo drive 62, the module 52 for controlling the servo drive of the protective shutter 54, 52—the module for controlling the servo drive 61 of the protective shutter 54;
the microprocessor module 44, the memory unit 45 of the microprocessor module, the first 46 and the second 50 additional microcontrollers;
the WiFi module 34, the GSM module 36 (in separate embodiments, the additional ETHERNET communication unit 38), the users are also allowed to select the operation modes of the active warning means 26, 27, 28, 33 individually (manually) in an operational and convenient manner in order to avoid occurrence of adverse reactions in individuals who have intruded into the room (also to avoid human epileptic reactions onto the lighting impulse signals). That is, the users, depending on the information received from the device 1 and depending on the situation at the site being guarded, are allowed to adjust the power, time, other operational characteristics of the active warning means 26, 27, 28, 33 individually remotely, by transmitting signals from their own electronic digital appliances. Therefore, the users, by means of the device 1 (that is in the “guarding” or “defense” modes or in the “alarm” state), are allowed either to reduce (or to terminate at all) an influence made by the active warning means 26, 27, 28, 33 or to increase the influence and/or time onto individuals who have penetrated into the room being guarded in unauthorized manner. Therewith, the original structure of the lighting warning means 28 and the light-emitting diode 29, the cooling system 30, the mirror cap 31, the device (the servo drive) 32 for the mirror cap 31, the module 47 for controlling the lighting warning means 28, the module 48 for controlling the servo drive of the mirror cap 31 enable controlling the operation and a flashing level of the lighting warning means 28 in a maximum precise manner. The structure of the gas or aerosol, or gas-aerosol warning means 33 allows using not only gaseous, but also aerosol warning means for dissipation being finely dispersed liquids, smokes, gas mixtures, which may form, within the guarded area, certain odors that may affect the offenders without any damage to their physical or mental health.

Such capabilities of the device 1 enable:
avoiding any health damage of an individual who is present in the room (e.g., if it is completely clear that this is not the offender or under other circumstances) made by the active warning means 26, 27, 28, 33;
or achieving a maximum disorientation and termination of actions of the offenders/intruders, increasing the time of such disorientation and affecting the intruders made by the active warning means 26, 27, 28, 33 that may cause them to leave the room quickly as well as allow increasing the time for a possible arrival of security or human rights groups.

The communication means (for the communication between the WiFi module 34 and the WiFi antenna 35, the GSM module 36 and the GSM antenna 37) and the software of the microprocessor module 44 enable one or several users, by means of their own electronic digital appliances, to “manipulate” with the device 1 remotely in a quick and convenient manner. The WiFi module 34 enables the device 1 to establish the Internet connection and, thus, to the electronic digital user appliances (via the Internet). The GSM module 36 supports voice call functions, SMS messaging, packet data transmission (GPRS, 2G, EDGE, 3G, 4G, 5G, M2M), and has an embedded memory to reproduce preliminary loaded voice files. Owing to the WiFi module 34 and the GSM module 36, it is also possible to establish the connection to an independent external centralized guard system in order to transmit messages (simultaneously with messages to the users), e.g., regarding an unauthorized intrusion into the room or other ones, thereby increasing a probability of the quick reaction to the events fixed by the device 1.

Therefore, the set of all the structural features of the invention (including its novel features), their mutual arrangement within the structure and mutual relations allow achieving the technical effect, namely, to increase the level, quality, and convenience of the protection of the room against the unauthorized intrusion, and allow the device 1 to react onto the events within such room quickly and effectively, at the same time informing the users regarding the same and to execute commands from the users, if necessary.

In order to increase the room surveillance level, in separate embodiments of the invention, additional optional (external) wireless sensors 57 may be used together with the device 1 (FIG. 2), such as motion, presence, glass breakage, smoke, flood and fire sensors, an electromagnetic door opening sensor, a gas leakage sensor, each of them comprises a corresponding receiving-transmitting module. In order to increase the room security level, in separate embodiments of the invention, additional remote (external) active warning means (not depicted in the drawings) may be used together with the device 1, including additional low-frequency alarm, high-frequency alarm, lighting warning means, gas or aerosol, or gas-aerosol warning means, each of them comprises the corresponding receiving-transmitting module. And in such embodiments, the device 1 comprises the signal receiving/transmitting and processing radio-frequency module 39 with the antenna 40 (FIG. 2) for receiving/transmitting and processing signals from these additional remote (external) active warning means and from the optional (external) wireless sensors 57. The signal receiving/transmitting and processing radio-frequency module 39 with the antenna 40 receives the signals from said additional sensors 57, the additional active warning means, and transmits these signals to the microprocessor module 44 for further processing and reacting, as well as the module 39 with the antenna 40 allows the users to connect and to establish the mutual connection to their own external electronic digital appliances in order to enable the remote activation of the device 1 in the “alarm” mode.

As it has been mentioned already, in separate embodiments of the invention, the device 1, as the alternative/additional communication means, further comprises the ETHERNET communication unit 38 that is coupled to the microprocessor module 44. Such solution is for cases, when the main communication means (the WiFi module 34 and the GSM module 36) under certain circumstances are not able to work effectively, e.g., due to an absence of a strong “Internet coverage” or in cases, when the intruders may use “damping” of the WiFi and/or GSM communication. The ETHERNET communication unit 38 establishes the communication via local wired computer, industrial networks, which will not allow “dampening/destroying” such communication from outside without mechanical intrusion into the network.

### BRIEF DESCRIPTION OF THE DRAWINGS

A practical implementation and industrial applicability of the portable, hand-held, standalone guard device with the active warning means will be explained by schematic illustrations of the structure, where:

FIG. 1 depicts the portable, hand-held, standalone guard device 1 in an exploded condition;

FIG. 2 depicts a block diagram of the structural and electronic elements of the device 1;

FIG. 3 depicts the removable front panel 6 and the removable protective cap 7;

FIG. 4 depicts the lighting warning means 28 (a two-perspective view);

FIG. 5 depicts the gas or aerosol, or gas-aerosol warning means 33.

Nomenclature, list of elements, assemblies, details of the invention structure:
1—the portable, hand-held, standalone guard device;
2—the housing;
3—the protective envelope of the housing 2;
4—the walls of the protective envelope 3;
5—the removable rear panel of the device 1;
6—the removable front panel of the device 1;
7—the removable protective cap of the removable protective panel 6;
8—the first internal frame element;
9—the second internal frame element (being the housing for the gas or aerosol, or gas-aerosol warning means 33);
10—the display;
11—the microphone;
12—the motion/movement fixation module;
13—the video camera with its own microcontroller 13.1;
14—the starter unit;
15—the button for power-up and activation of the light-emitting diode indicator 16;
16—the light-emitting diode indicators;
17—the infrared intrusion sensor (being the infrared motion sensor having the mirror lens to enhance sensitivity);
18—the radio-frequency intrusion sensor (being the radio-frequency motion/presence Doppler sensor);
19—the main power and recharging unit;
20—the standalone power supply unit;
21—the batteries;
22—the module (having the software) of the standalone power supply unit 20;
23—the pressure sensor;
24—the temperature and humidity sensor that is integrated within the pressure sensor 23;
25—the illumination change control sensor;
26—the low-frequency alarm (being the acoustic warning means);
27—the high-frequency alarm (being the acoustic warning means);
28—the lighting warning means;
29—the light-emitting diode of the lighting warning means 28;
30—the cooling system of the lighting warning means 28;
31—the mirror cap of the lighting warning means 28;
32—the device (being the servo drive) for the automatic opening of the mirror cap 31 of the lighting warning means 28;
33—the gas or aerosol, or gas-aerosol warning means;
34—the WiFi module;
35—the WiFi antenna;
36—the GSM module;
37—the GSM antenna;
38—the ETHERNET communication unit;
39—the signal receiving/transmitting and processing radio-frequency module;
40—the antenna of the radio-frequency module 39;
41—the wireless reader of cards and ISO/IEC 14443 standards tags (RFID);
42—the wireless keys reading antenna;
43—the main electronic control board;
44—the microprocessor module;
45—the memory unit of the microprocessor module;
46—the first additional microcontroller comprising:
47—the module for controlling the lighting warning means 28;
48—the module for controlling the servo drive of the mirror cap 31 of the light-emitting diode 29 of the lighting warning means 28;
49—the module for controlling the low-frequency alarm 26;
50—the second additional microcontroller comprising:
51—the module for controlling the servo drive 62 for dissipating the gas or aerosol, or gas-aerosol warning means 33;
52—the module for controlling the servo drive 61 of the protective shutter 54 of the system for dissipating the gas warning means 33;
53—the module for controlling the high-frequency alarm 27;
54—the protective shutter of the nozzle 55 of the gas or aerosol, or gas-aerosol warning means 33;
55—the nozzle of the gas or aerosol, or gas-aerosol warning means 33;
56—the power supply device that is consistent with the QC 1.0, QC 2.0, QC 3.0 charging protocols;
57—the optional (external) wireless sensors;
58—the battery management system for the batteries 21 (the BMS-system);
59—the MOSFET power keys on the field-effect transistors;
60—the vessel of the gas or aerosol, or gas-aerosol warning means 33;
61—the servo drive of the protective shutter 54 of the nozzle 55 of the gas or aerosol, or gas-aerosol warning means 33;
62—the servo drive of the lever for discharging the gas or aerosol, or gas-aerosol agent;
63—the pad (the PIR window) for the infrared intrusion sensor 17 and for the video camera 13.

### Static Description of the Structure

The portable, hand-held, standalone guard device 1 with the active warning means is a complex structure comprising various structural and electronic elements, assemblies, details, namely: a structural base (being the housing 2), the intrusion sensors, the control sensors, the power supply elements, the microprocessor module 44, the memory units, the software, the active warning means, modules and drivers for controlling the active warning means, the communication means.

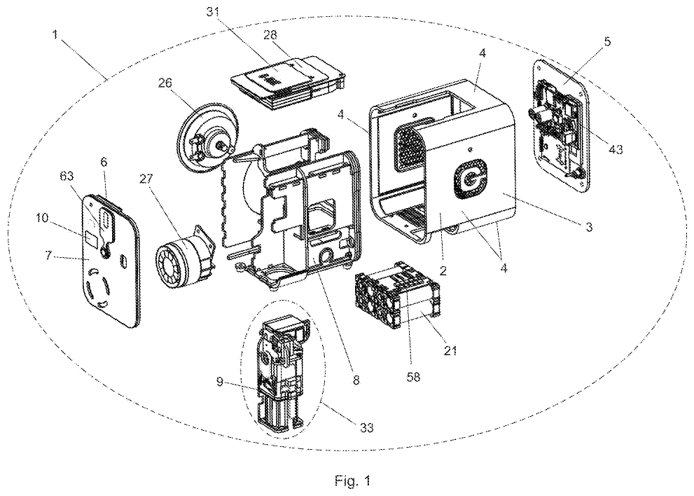

The device 1 comprises the housing 2 that represents the structural base of the device 1 and is formed of the protective envelope 3 with the walls 4, as well as it comprises the first 8 and the second 9 internal frame elements which are removable from the protective envelope 3 and insertable into the protective envelope 3 (FIG. 1). The removable rear panel 5 (FIG. 1) and the removable front panel 6 with the removable protective cap 7 (FIG. 1, 3) are secured to the housing 2.

The first internal frame element 8 is the base which serves for mounting/fixing thereon (therein) the following elements: the lighting warning means 28, the low-frequency alarm 26, the high-frequency alarm 27, the video camera 13, the standalone power supply unit 20 and the batteries 21 (FIG. 1), and other elements.

The second internal frame element 9 is a housing for the gas or aerosol, or gas-aerosol warning means 33 (FIG. 1, 5), and it is mounted into the first internal frame element 8 during the assembling.

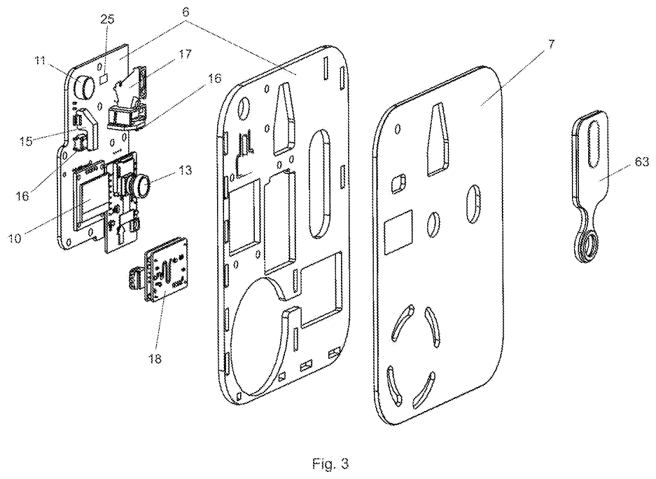

The following elements are mounted on the removable front panel 6 (FIG. 1, FIG. 3):
the display 10;
the microphone 11;
the video camera 13 with the microcontroller 13.1;
the button 15 for power-up of the device 1 and the light-emitting diode indicators 16;
the infrared intrusion sensor 17 (being an environmental infrared radiation change sensor that relates to the motion/movement fixation module 12), and it is connected and operates via the MOSFET power keys 59 on the field-effect transistors;
the radio-frequency intrusion sensor 18 (being a radio-frequency motion/presence Doppler sensor that relates to the motion/movement fixation module 12), and it is connected and operates via the MOSFET power keys 59 on the field-effect transistors;
the light-emitting indicators 16 (within the area of the power-up button 15 and within the area of the infrared intrusion sensor 17) (FIG. 3);

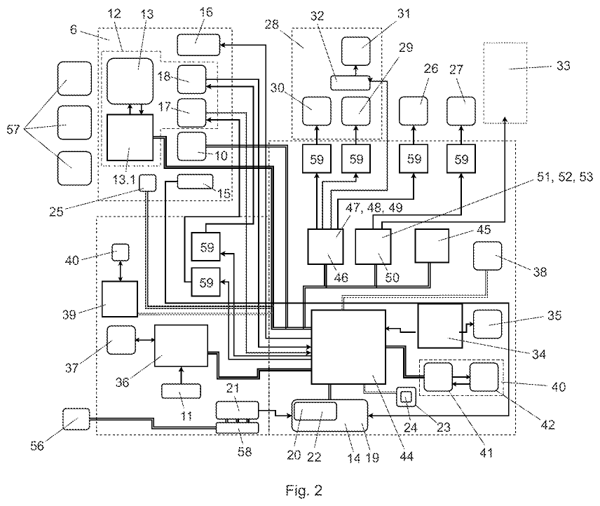

All the elements of the motion/movement fixation module 12 are mounted on the removable front panel 6 (FIG. 2): the video camera 13, the infrared intrusion sensor 17, and the radio-frequency intrusion sensor 18, wherein the motion/movement fixation module 12 may be mounted not only on the front panel 6, but in any location within the housing 2. The removable protective cap 7 is mounted on top of the removable front panel 6, wherein the pad 63 (the PIR window) for the infrared intrusion sensor 17 and the video camera 13 is arranged on the cap (FIG. 1, 3).

The following elements are secured to the internal plane of the removable rear panel 5 (FIG. 1): the main electronic control board 43 with the microprocessor module 44, with the main power and recharging unit 19, and with the standalone power supply unit 20; the starter unit 14 that is combined with the main power and recharging unit 19, with the standalone power supply unit 20, wherein the starter unit 14 is connected to the power-up button 15 for power-up of the device 1 and the light-emitting diode indicators 16. The main electronic control board 43 also comprises other elements which are designated in FIG. 2.

The device 1 further comprises control sensors, namely: the pressure sensor 23 with the integrated temperature and humidity sensor 24 is arranged within the housing 2 (FIG. 2); the illumination change control sensor 25 is mounted on the removable front panel 6 (FIG. 2, 3) (the change of illumination directly near the device 1 is meant).

The power supply means of the device 1 is made in the form of the main power and recharging unit 19 and the standalone power supply unit 20 with the batteries 21 and with the battery management system 58 (the BMS-system 58) (FIG. 2). The standalone power supply unit 20 is connected to the electronic digital module 22 with a software. The module 22 is based on a separate controller that is mounted on the main electronic control board 43 (FIG. 1) for controlling the device 1. The standalone power supply unit 20 is configured to be recharged by a mains or an automobile power supply device and is arranged inside the housing 2. Furthermore, in separate embodiments of the invention, the device 1 further comprises the power supply device 56 (FIG. 1) that is consistent with the QC 1.0, QC 2.0, QC 3.0 charging protocols and is configured to connect to a battery management system 58 for the battery 21 of the standalone power supply unit 20.

A separate standard power converter for the GSM module (not depicted in the drawings) and a separate standard power converter for 5 Volt systems (not depicted in the drawings) also relate to the power supply means for the device 1.

### Communication, Signal Transmission Means.

The device 1 comprises the communication means in the form of the WiFi module 34 with the WiFi antenna 35, the GSM module 36 with the GSM antenna 37 (FIG. 2). The WiFi module 34 with the WiFi antenna 35 are intended to provide the operation of the device 1 in the wireless Internet network. The GSM module 36 with the GSM antenna 37 may be made in the form of a digital cellular communication modem of the GSM900/1800 standard that is controlled by AT-commands according to the RS232 protocol from the microprocessor module 44.

In separate embodiments, as the communication means, the device 1 further comprises the ETHERNET communication unit 38 (FIG. 2) that is coupled to the microprocessor module 44. The ETHERNET communication unit 38 allows associating the operation of the device 1 to the LAN network.

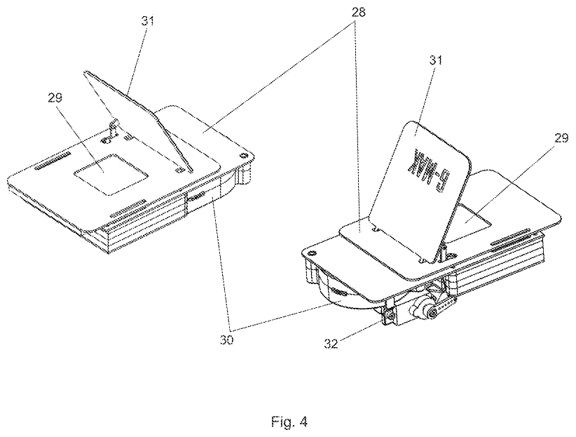

The device 1 comprises the active acoustic 26, 27, the lighting 28, and the gas 33 warning means. The acoustic warning means is made in the form of the low-frequency 26 and the high-frequency 27 alarms (FIG. 1, 2). The lighting warning means 28 is made as the module with a powerful light-emitting diode 29 and further comprises the cooling system 30 (12V turbine cooler), the mirror cap 31 with the automatic opening device 32 (the servomotor) (FIG. 4).

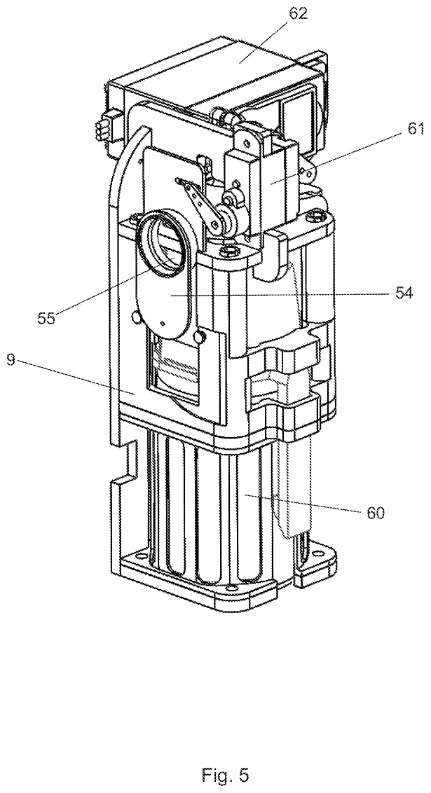

The gas warning means 33 is made as the gas or aerosol, or gas-aerosol warning means and comprises: the vessel 60 for the gas or aerosol, or gas-aerosol agent, the nozzle 55, the shutter 54 for the nozzle, the servo drive 61 for the shutter 54, the servo drive 62 of the lever for discharging the gas or aerosol, or gas-aerosol agent. Said elements are mounted in the second internal frame element 9 (FIG. 5).

All the mentioned active warning means 26, 27, 28, 33 are mounted in the first internal frame element 8 of the housing 2.

In separate embodiments of the invention, the device 1 comprises additional remote (external) active warning means (not depicted in the drawings) which may be made in the form of the low-frequency and/or high-frequency alarm, and/or the lighting warning means, and/or in the form of the gas or aerosol, or gas-aerosol warning means. Each of the additional remote (external) active warning means comprises the receiving-transmitting module. Said additional remote (external) active warning means are made as separate devices (which do not constitute a subject matter of the present invention) and may be mounted in different locations within the room and be interconnected to the device 1.

Furthermore, in separate embodiments of the invention, the device 1 may have an established connection to and operate with optional (external) wireless sensors 57 (FIG. 2), namely: with motion, presence, glass breakage, smoke, flood and fire sensors, an electromagnetic door opening sensor, a gas leakage sensor. Each of these optional (external) wireless sensors 57 comprises the receiving-transmitting module. Said optional (external) wireless sensors 57 are made as separate devices (which do not constitute a subject matter of the present invention) and may be mounted in different locations within the room.

Thus, in said separate cases of use of the additional remote (external) active warning means and the optional (external) wireless sensors 57, the device 1 comprises the signal receiving/transmitting and processing radio-frequency module 39 (FIG. 2) for receiving/transmitting and processing signals from the additional remote (external) active warning means and/or from the optional (external) wireless sensors 57. The module 39 comprises the antenna 40 (FIG. 2).

The signal receiving/transmitting and processing radio-frequency module 39 (with the antenna 40) may be mounted within the housing 2 and configured to connect to and to establish an intercommunication with the additional remote (external) active warning means and/or with the optional (external) wireless sensors 57. Also, the signal receiving/transmitting and processing radio-frequency module 39 (with the antenna 40) is configured to connect and to establish an intercommunication with the external electronic digital user appliances to activate the device 1 in the “alarm” state remotely.

The device 1 comprises the wireless reader 41 of cards and ISO/IEC 14443 standards tags (e.g., a RFID 13.56 MHz tags, but without limitation thereto) to the wireless keys reading antenna 42 (e.g., a RFID antenna, but without limitation thereto) (FIG. 2). The wireless reader 41 of cards and standards tags with the antenna 42 is intended to turn on/off the device 1 by the user by means of, e.g., a card or a breloque with the RFID-tag chip.

### The Microprocessor Module 44

The device 1 comprises the microprocessor module 44 having the main memory unit 45 (FIG. 2) and the software. The microprocessor module 44 is mounted on the main electronic control board 43 and is interconnected to and has channels for exchanging signals, data, information with the most of the elements of the device 1 directly or indirectly (FIG. 2). The microprocessor module 44, by means of the communication means (in the form of the WiFi module 34 and the GSM module 36) is interconnected to and has channels for exchanging signals, data, information with the external software that is located in the wide area network and in local area networks.

The microprocessor module 44 and its software are configured and set to control the operation of the device 1 in the main modes: “standby”, “monitoring”, “guarding”, “defense” modes and in an “alarm” state, and their operation is described hereinafter.

In order to control of the operation of the device 1 in said four main modes being the “standby”, “monitoring”, “guarding”, “defense” modes and in the “alarm” state, the structure of the invention comprises two additional microcontrollers 46 and 50 (FIG. 2) which are connected to and coupled to the microprocessor module 44 and its software.

The first additional microcontroller 46 comprises the module 47 for controlling the lighting warning means (that is connected and operates via the MOSFET power key 59 on the field-effect transistors), the module 48 for controlling the servo drive of the mirror cap of the lighting warning means 28, the module 49 for controlling the low-frequency alarm (that is connected and operates via the MOSFET power key 59 on the field-effect transistors).

The second additional microcontroller 50 comprises: the module 51 for controlling the servo drive 62 of the lever for dissipating the gas (or aerosol, or gas-aerosol) warning means 33; the module 52 for controlling the servo drive 61 of the protective shutter 54 of the nozzle 55 of the system for dissipating the gas warning means 33; the module 53 (that is connected and operates via the MOSFET power key 59 on the field-effect transistors) for controlling the high-frequency alarm 27.

In separate embodiments of the invention, the microprocessor module 44 is coupled to the light-emitting indicators 16 (FIG. 2). In these embodiments, the software of the microprocessor module 44 is set to display the change of the operation modes and state of the device 1 on the removable front panel 6 by means of the light-emitting diode indicators 16. Therefore, the user, if it is necessary in certain circumstances, will be allowed to visually observe the change of the operation modes of the device 1 on the removable front panel 6 of the device owing to the operation of the light-emitting indicators 16.

### Description of the Device Operation

The device 1 may be transported to any site of use thereof easily, conveniently, and safely. The standalone operation of the device 1 does not require a mandatory presence of any stationary communications (power supply, computer and other networks, stationary communication means). The portable, hand-held, standalone guard device 1 with the active warning means is mounted at the site of its use (in an apartment, in a house, in an office, a warehouse or another space). Preliminary, the main power and recharging unit 19 and the standalone power supply unit 20 with the batteries 21 must be charged as fully as possible. The user activates the operation of the device 1 by switching on the button 15 of the starter unit 14, and the device 1 starts to operate at least in the “standby” mode. The device 1 may be switched on by means of the button 15. Also, the switching on/off may be performed by reading (by the wireless keys reading antenna 42 of the wireless reader 41 of cards and tags) a separate RFID-tag that be possessed by the user in a form of a card or a breloque with the RFID-tag chip.

Furthermore, it is possible to switch on the device 1 remotely by transmitting the corresponding signals by means of the software of the electronic digital user appliance. After the device 1 is switched on, said power supply means provide the power to all the corresponding elements of the device 1.

The protective envelope 3 with the walls 4, the removable rear panel 5, and the removable front panel 6 with the removable protective cap 7 of the housing 2 provide an external protection of the internal details and elements of the device 1 during possible mechanical impacts (a fall, a stroke etc.).

The display 10 displays at least the unique QR-code, the operation modes of the device 1, levels of the WiFi, GSM signals, and a version of the microprocessor module 44 software. The unique QR-code forms the software of the microprocessor module 44 and “transmits” the QR-code to the display 10, while the user may read this QR-code from the display by his own electronic digital appliance and establish the communication with the device 1 (this communication is unique each time).

The communication means in the form of the WiFi module 34 and the WiFi antenna 35, the GSM module 36 and the GSM antenna 37, and the software of the microprocessor module 44 enable one or several users to “manipulate” the device 1 remotely, i.e., when the users are not present in the room, where the device 1 is mounted. The users establish this communication with the device 1 by means of their own electronic digital appliances (computers, notebooks, smartphones, etc.). The WiFi module 34 enables the device 1 to establish the Internet connection and, thus, to establish the communication and data exchange with the electronic digital user appliances via the Internet. The GSM module 36 supports voice call functions, SMS messaging, packet data transmission (GPRS, 2G, EDGE, 3G, 4G, 5G, M2M), and has an embedded memory to reproduce preliminary loaded voice files. Furthermore, in separate embodiments and operation cases of the invention, the ETHERNET communication unit 38 allows associating the operation of the device 1 to the LAN network which the users are also allowed to be connected to, as well as to be in communication with the device 1 by means of the same.

The invention implies that in separate embodiments, when the device 1 is used with the additional remote (external) active warning means and/or with the optional (external) wireless sensors 57, it (the device 1), while being in communication with said means and the sensors 57, further comprises the signal receiving/transmitting and processing radio-frequency module 39 with the antenna 40 that receives the signals from the additional sensors 57, from the additional active warning means, and transmits these signals to the microprocessor module 44 for further processing and reacting. Also, the signal receiving/transmitting and processing radio-frequency module 39 with the antenna 40 allows the users to connect and to establish the mutual communication with their own external electronic digital appliances in order to enable the remote activation of the device 1 in the “alarm” state.

The established communication with the device 1 enables the users to perform the following actions remotely: to receive messages, data, and information from the device 1; to transmit messages, control and other signals to the device 1, to track the mode and the state of the device 1, to switch on the device 1 remotely, to change the operation modes of the device 1.

The power is supplied to the device 1 by means of the operation of the main power and recharging unit 19 and the standalone power supply unit 20 with the batteries 21 and with the battery management system 58 (the BMS-system 58). The novel feature of the proposed invention is that the standalone power supply unit 20 is connected to the electronic digital module 22 with the software. The module 22 is based on a separate controller that is mounted on the main electronic control board 43 (FIG. 1) for controlling the device 1, and that performs functions of controlling processes of standalone powering and short circuit protection being a (POWER management system), and functions of controlling a charge/discharge of a separate cell of the battery 21, controlling and cutoff under an extra low voltage, switching on and off a measurement of energy consumption by the standalone power supply unit 20 (the BMS-system 58). The standalone power supply unit 20 is configured to be recharged by a mains or an automobile power supply device and is arranged inside the housing 2. Furthermore, in separate embodiments of the invention, the power supply device 56, which is consistent with the QC 1.0, QC 2.0, QC 3.0 charging protocols, is configured to connect to the battery management system 58 for the battery 21 of the standalone power supply unit 20. Thus, in these embodiments, the standalone power supply unit 20 is configured to be charged by the power supply device 56 that is consistent with the QC 1.0, QC 2.0, QC 3.0 charging protocols. The power is supplied to the elements of the device 1 by means of the separate standard power converter for the 5 Volt systems and the separate standard power converter for the GSM module.

The microprocessor module 44 together with its software is the main structural element that enables managing the operation of the device 1. The microprocessor module 44 is coupled to other elements of the device 1 in such a way as shown on FIG. 2. The microprocessor module 44 together with its software performs at least the following actions and functions:
receives all signals which come from the motion/movement fixation module 12 (from the sensors 17, 18, the microphone 11, the video camera 13), from the sensors 23, 24, 25, from the optional (external) wireless sensors 57 (if they are present);
processes and analyzes the received signals;
“manages” the operation of the active warning means 26, 27, 28, 33;
“manages” the operation of the optional (external) wireless active warning means (if they are present);
forms and transmits, via the communication means, the signals, data, information to the electronic digital user appliances or to other recipients defined by the users;
receives (via the communication means), processes, and analyzes the signals, data, information from the user electronic digital appliances or from other recipients defined by the users.

The device 1 is able to operate in the four main modes: “standby”, “monitoring”, “guarding”, “defense”, as well as in the “alarm” state.

The “standby” mode is a passive state mode of the device 1 with the intrusion sensors 17, 18 and the control sensors 23, 24, 25 switched off. The following takes place in the “standby” mode:
reading a physical state of the device 1 (the microprocessor module 44, by means of the software, “reads” a power status, a presence, and a power of the communication signals, other parameters of the device 1);
the software of the microprocessor module 44 transmits the technical messages and reminder signals to the electronic digital user appliances indicating that the device 1 is not in any of the active operation modes “monitoring” or “guarding”, or “defense”, or in the “alarm” state.

In the “standby” mode, the software of the microprocessor module 44 is not able to turn on any active warning means.

The users, at their own request and by means of transmission of the corresponding commands from their own electronic digital appliances and the communication means of the device 1, are enabled to switch on one of the active modes “monitoring” or “guarding”, or “defense”, at any moment. After the corresponding commands are received by the microprocessor module 44 from any one of the communication means (from the WiFi module 34, the GSM module 36, the ETHERNET communication unit 38), the microprocessor module 44, by means of the software, activates the “monitoring” or “guarding”, or “defense” modes.

The “monitoring” mode is the active mode that fixes events according to the algorithm that is set by software of the microprocessor module 44. During the “monitoring” mode, any one of the intrusion sensors 17, 18 and/or control sensors 23, 24, 25 of the motion/movement fixation module 12 is actuated. That is, said sensors are in the active mode and are operatively activated in the following cases: somebody/something has penetrated into the room or there are movements within the room (the sensors 17, 18), while the atmospheric pressure is changing (the sensor 23), e.g., in case of the flood or fire within the room (the sensor 24), in case of the illumination change (the sensor 35). Furthermore, the temperature and humidity sensor 24 that is integrated into the pressure sensor 23 is also used to evaluate service parameters inside the device 1 itself, e.g., this sensor 24 “tracks” a possible overheat of the power supply elements 19, 20, the batteries 21, or transmits a notification regarding the humidity increase within the room to the microprocessor module 44. Also, during the “monitoring” mode, the data regarding the occurring events histories is recorded to the memory unit 45 of the microprocessor module 44 (each “event” is recorded; during the recording, each “event” gains a corresponding “time stamp” with accuracy of second and a corresponding code of the event itself); the photofixation is performed (the video camera 13 that allows making a series of from 3 to 10 pictures, when the motion is detected, but without limitation thereto), the technical messages to the electronic digital user appliances are transmitted, and the communication with the electronic digital user appliances is maintained. The main function of the “monitoring” mode is to monitor the internal space of the room in order to detect the motion or other changes within the room, and to transmit the corresponding messages and photographs regarding the detected motion or changes within the room to the electronic digital user appliances. In the “monitoring” mode, the software of the microprocessor module 44 is not able to turn on any active warning means.

The “guarding” mode is the active mode (all the intrusion sensors 17, 18 and the control sensors 23, 24, 25 are switched on), and during this mode, according to the algorithm set by the software of the microprocessor module 44, the room intrusion is detected, the events are fixed, the data regarding the events history is recorded (in the memory unit 45 of the microprocessor module 44), and the device 1 is switched (transited) to the “alarm” state. During the “guarding” mode, as well as during the “monitoring” mode, any one of the intrusion sensors 17, 18 and/or control sensors 23, 24, 25 of the motion/movement fixation module 12 is actuated as described above. The main functions of the “guarding” mode lie in transmission of the alarm messages, photographs regarding the intrusion into the room to the electronic digital user appliances, i.e., in the “guarding” mode, when the intrusion into the room is fixed, the software of the microprocessor module 44 forms and transmits the messages regarding the intrusion into the room and regarding the switching of the device 1 into the “alarm” state (that is described hereinafter) to the electronic digital user appliances. Therewith, the “guarding” mode enables the user, by means of his own electronic digital appliance, to transmit commands regarding the selective switching on/off of the active warning means 26, 27, 28, 33 “manually” and individually.

The “defense” mode is the active mode with all the intrusion sensors 17, 18 and the control sensors 23, 24, 25 switched on. In the “defense” mode, the device 1 is set and operates according to the “security zone intrusion detection” algorithm set by the software of the microprocessor module 44, that is, when any one of the intrusion sensors 17, 18 and/or control sensors 23, 24, 25 is actuated, according to the corresponding algorithm of the software of the microprocessor module 44, the device 1 will switch to the “alarm” state. In the “defense” mode, the device 1 operates almost in the same way as in the “guarding” mode, however, the software of the microprocessor module 44 in the “defense” mode is configured and set to automatically transmit the control signals for the activation of the active warning means 26, 27, 28, 33 (in contrast to the “guarding” mode, where the user “manually” transmits the commands regarding the selective switching on/off of the active warning means 26, 27, 28, 33). It should be noted that this automatic transmission of the control signals for the activation of the active warning means 26, 27, 28, 33 is possible under the proviso that such permissions for the activation of the active warning means 26, 27, 28, 33 are preliminary switched on by the user in the settings of the software of the microprocessor module 44. Also, the settings of the software of the microprocessor module 44 for the “defense” mode are configured to allow the users to switch on/off any one of the active warning means 26, 27, 28, 33 by transmitting the signals from the user electronic digital appliances. In the “defense” mode, the motion/movement fixation module 12 with the video camera 13 perform the photofixation of the events. The software of the microprocessor module 44 “manages” the transmission of the technical messages to the user electronic digital appliances and maintains the continuous communication with the user electronic digital appliances.

As mentioned previously, the device 1 transits to the “alarm” state from the “guarding” mode (manually) and from the “defense” mode (automatically and/or manually). In the “alarm” state, the software of the microprocessor module 44 forms and transmits the messages regarding the intrusion into the room and regarding the switching of the device 1 into the “alarm” state to the electronic digital user appliances. Also, the software of the microprocessor module 44 forms and transmits the control signals for the activation of all or a part of the active warning means 26, 27, 28, 33. The activation of all or the part of the active warning means 26, 27, 28, 33 is made under the proviso that such permissions for the activation are preliminary switched on by the user in the settings of the software of the microprocessor module 44, and the software of the microprocessor module 44 is set such that it enables the user to switch on or off any of the active warning means 26, 27, 28, 33 individually “manually” and remotely by transmitting the signals from the electronic digital user appliances. It should be noted that in separate usage embodiments of the invention, the user electronic digital appliances may be represented by any modern communication and signal transmission means (phones, smartphones etc.), computers, radio signal transmitters (e.g., a portable radio console, but without limitation thereto). Furthermore, in the “defense” mode, according to the algorithm set by the software of the microprocessor module 44, the following occurs: the photofixation, the transmission of the technical messages to the user electronic digital appliances, and maintaining the communication with the user electronic digital appliances. Therefore, the user, on the basis on the information received from the device 1, depending on a situation, is enabled to individually control the active warning means 26, 27, 28, 33 operatively and conveniently, i.e., to switch on or off the low-frequency alarm 26 and/or the high-frequency alarm 27, and/or the lighting warning means 28, and/or the gas or aerosol, or gas-aerosol warning means 33, that, in turn, allows increasing the level and the quality of protection of the room against the unauthorized intrusion or to avoid this intrusion.

The microprocessor module 44 and its software control the operation of the device 1 in said four main modes being the “standby”, “monitoring”, “guarding”, “defense” modes and in the “alarm” state, by means of the two additional microcontrollers 46 and 50.

The first additional microcontroller 46 comprises several modules (47, 48, 49) for controlling the active warning means. The module 47 for controlling the lighting warning means (that is coupled to and operates via the MOSFET power key 59 on the field-effect transistors) “manages” the switching on/off, the power, the frequency of the flashing of the light-emitting diode 29 of the lighting warning means 28. The lighting warning means 28 is a system with a powerful light-emitting diode (a light temperature is not less than 6000K), the active cooling system 30, and the device 32 (being the servo drive) for the automatic opening of the mirror cap 31 that reflects the light in the required direction. A flashing algorithm of the light-emitting diode is controlled by the software settings of the microprocessor module 44 and the first additional microcontroller 46, thereby enabling controlling the parameters of the power, frequency, and duty cycle. Also, the lighting warning means 28 participates in the formation of the warning signals of the device 1 by creating short low-power light impulses. The module 47 for controlling the lighting warning means enables changing dynamic and frequency parameters of the flashing of the light-emitting diode 29 in a pulse mode (in a “stroboscope” operation mode), thereby allowing setting and utilizing such operation modes of the light-emitting diode 29 in the pulse mode which avoid the occurrence of epileptic reactions in individuals to such light impulse signals. The module 48 for controlling the servo drive 32 of the mirror cap 31 of the lighting warning means 28 allows locating the mirror cap 31 in such a position relative to the light-emitting diode 29 that could allow achieving a certain required direction of the light flashings and the most effective operation of the lighting warning means 28. Also, the first additional microcontroller 46, via the MOSFET power key 59 on the field-effect transistors, controls the cooling system 30 (turbine cooler) of the lighting warning means 28.

The module 49 for controlling the first additional microcontroller 46 “controls” the low-frequency alarm 26 and adjusts the frequency (e.g., 420 Hz, but without limitation thereto) and an acoustic power (105 Db, but without limitation thereto) of the low-frequency alarm 26 during its operation.

The second additional microcontroller 50 comprises several modules (51, 52, 53) for controlling the active warning means. The module 51 activates and deactivates the servo drive 62 of the lever for dissipating the gas/aerosol/mixture of the gas (aerosol or gas-aerosol) warning means 33. The module 52 activates and deactivates the servo drive 61 of the protective shutter 54 that closes or opens the nozzle 55 of the vessel 30 for the gas or aerosol, or gas-aerosol warning means 33.

The control module 53 that is connected to and operates via the MOSFET power key 59 on the field-effect transistors sets the frequency and the acoustic power of the high-frequency alarm 27 during its operation. The high-frequency alarm 27 comprises an embedded binary frequency generator (e.g., 3.8 kHz, 4.08 kHz, but without limitation thereto) with a step-up voltage transformer that is loaded by a piezoceramic acoustic radiating membrane.

In the “alarm” state, all the active warning means may operate simultaneously or selectively depending on the settings of the software of the microprocessor module 44, of the additional microcontrollers 46, 50, and depending on the commands from the users.

Both additional microcontrollers 46 and 50 enable quick changing the operation parameters of the active warning means 26, 27, 28, 33 (as well as switching on/off the lighting 28, the acoustic 26, 27, and the gas/aerosol/gas-aerosol 33 active warning means) due to the commands from the microprocessor module 44 that, in turn, operates with the preliminary installed software. The operation parameters of the active warning means 26, 27, 28, 33 may be changed by the user by transmitting commands from his own electronic digital appliance (e.g., from the phone, smartphone, computer etc.). Owing to the operation of the light-emitting diodes 16, the user, if it is necessary and in certain circumstances, is allowed to visually observe the change of the operation modes of the device 1 on the removable front panel 6 of the device 1.

Therefore, the interconnection between the microprocessor module 44, the additional microcontrollers 46, 50, and the modules 47, 48, 49, 51, 52, 53 allows the device 1 to operate automatically in the four different modes: “standby” or “monitoring”, or “guarding”, or “defense”, as well as allows switching the device 1 in the “alarm” state automatically and operatively.

The presence of the various active acoustic 26, 27, lighting 28, and gas or aerosol, or gas-aerosol 33 warning means being interconnected to the microprocessor module 44, to the additional microcontrollers 46, 50, and to the modules 47, 48, 49, 51, 52, 52 allows using the active warning means selectively and simultaneously depending on the situation at the site being guarded.

The communication means in the form of the WiFi module 34 with the WiFi antenna 35, the GSM module 36 with the GSM antenna 37, the ETHERNET communication unit 38 being interconnected to the microprocessor module 44 allows the users to exchange data and signals with the device 1 operatively, and to control the active warning means of the device individually (manually) depending on the situation (the selective switching on/off of the active warning means) and to perform the manual selection of the operation modes by the active warning means.

The structure of the housing 2 and the main power and recharging unit 19, the standalone power supply unit 20 with the batteries 21 and with the module 22 (with the software) allow using the device 1 on the standalone basis within various rooms and to move the device 1 to various locations of various rooms quickly, if it is necessary.

During the operation of the device 1 in the various modes being “standby”, “monitoring”, “guarding”, “defense”, as well as in the “alarm” state”, the following occurs:
automatic monitoring of the events that may take place within the space of the object being guarded;
message, signal, and data exchange with the user electronic digital appliances;
protection of the room against the unauthorized intrusion or avoiding a possible intrusion.

The proposed portable, hand-held, standalone guard device with the active warning means has passed wide tests during its experimental manufacture, as well as in the process of its use within various rooms for the room surveillance and for its guarding.

The test results have shown that the structure of the proposed invention allows creating the proposed portable, hand-held, standalone guard device with the active warning means having the structure that is small-sized, convenient, and safe for use in amenity and other rooms. The proposed structure of the device 1 allows performing:
the control of the room and to fix the events within the room being guarded;
data and signal exchange between the structural elements of the device 1 and with the user electronic digital appliances;
the quick automatic or manual activation or deactivation of the active warning means 26, 27, 28, 33.

Examples of a specific industrial embodiment of the proposed invention, its use are mentioned above as the best exemplary embodiments.

The proposed portable, hand-held, standalone guard device with the active warning means meets all the requirements of its use, application, and commonly accepted safety rules regarding use of such surveillance and guard devices.

What is claimed is:

1. A double-circuit electric boiler, comprising: a power supply system, control elements, a housing (5) having inside a container (1) for a water of a hot water supply circuit and a container (2) for a heat-carrying agent of a warming circuit, wherein at least one electric heater (3) of the heat-carrying agent of the warming circuit is mounted inside the container (2), and each of said two containers (1), (2) comprises an inlet (9,11) and an outlet ducts (8,10), and the container (1) for the water of the hot water supply circuit comprises a heat insulation layer (4), characterized in that the container (2) for the heat-carrying agent of the warming circuit, along with the at least one electric heater (3) of the heat-carrying agent of the warming circuit mounted in the container (2), is mounted and sealably and rigidly secured inside the container (1) for the water of the hot water supply circuit such that one of surfaces of the container (2) for the heat-carrying agent of the warming circuit is an outer wall (7) that is disposed and secured outside the container (1) for the water of the hot water supply circuit such that an inner surface (29) of the outer wall (7) is in a contact with a mounting wall (16) of the container (1) of the hot water supply circuit, and an outer surface (30) of the outer wall (7) is disposed outside the container (1) of the hot water supply circuit, wherein the outer surfaces of inner walls (6) of the container (2) of the heat-carrying agent of the warming circuit that is disposed inside the container (1) for the water of the hot water supply circuit are in contact with the water of the hot water supply circuit inside the container (1) for the water of the hot water supply circuit, furthermore, the at least one electric heater (3) for the heat-carrying agent of the warming circuit is fully isolated by the inner walls (6) of the container (2) of the warming circuit from a contact with the water of the hot water supply circuit that is disposed inside the container (1) of the hot water supply circuit, wherein the outlet duct (8) for drain of the heat-carrying agent from the container (2) of the warming circuit and the inlet duct (9) for supplying the heat-carrying agent into the container (2) of the warming circuit are sealably mounted and secured in technological openings of the outer wall (7) of the container (2) of the warming circuit, and their end openings are sealably coupled to the corresponding technological openings of the container (2) of the warming circuit inside the container (1) of the hot water supply circuit, and an outlet duct (10) for drain of the water from the container (1) of the hot water supply circuit and an inlet duct (11) for supplying the water into the container (1) of the hot water supply circuit are sealably mounted and secured in the corresponding technological openings of one of the walls of the container (1) of the hot water supply circuit such that their end openings are disposed inside the container (1) of the hot water supply circuit and areas of these outlet (10) and inlet (11) ducts, which are disposed inside the container (1) for the water of the hot water supply circuit, are fully isolated by the inner walls (6) of the container (2) of the heat-carrying agent of the warming circuit from a contact with the heat-carrying agent in the container (2) of the warming circuit, furthermore, inside the container (2) of the warming circuit, there is mounted a temperature sensor (12) for the heat-carrying agent in the container (2) of the warming circuit such that this temperature sensor (12) is fully isolated by the inner walls (6) of the container (2) from a contact with the water in the container (1) of the hot water supply circuit, and inside the container (1) of the hot water supply circuit, there is mounted a temperature sensor (13) for the water in the container (1) such that this temperature sensor (13) is fully isolated by the inner walls (6) of the container (2) from a contact with the heat-carrying agent in the container (2) of the warming circuit.

2. A double-circuit electric boiler, comprising: a power supply system, control elements, a housing (5) having inside a container (1) for a water of a hot water supply circuit, the container (1) having inside at least one electric heater (27) for the water of the hot water supply circuit, and a container (2) for a heat-carrying agent of a warming circuit, wherein at least one electric heater (3) of the heat-carrying agent of the warming circuit is mounted inside the container (2), and each of said two containers (1), (2) comprises an inlet and an outlet ducts (9,11 and 8,10), and the container (1) for the water of the hot water supply circuit comprises a heat insulation layer (4), characterized in that the container (2) for the heat-carrying agent of the warming circuit, along with the at least one electric heater (3) of the heat-carrying agent of the warming circuit mounted in the container, is mounted and sealably and rigidly secured inside the container (1) for the water of the hot water supply circuit such that one of surfaces of the container (2) for the heat-carrying agent of the warming circuit is an outer wall (7) that is disposed and secured outside the container (1) for the water of the hot water supply circuit such that an inner surface (29) of the outer wall (7) is in a contact with a mounting wall (16) of the container (1) of the hot water supply circuit, and an outer surface (30) of the outer wall (7) is disposed outside the container (1) of the hot water supply circuit, wherein the outer surfaces of inner walls (6) of the container (2) of the heat-carrying agent of the warming circuit that is disposed inside the container (1) for the water of the hot water supply circuit are in a contact with the water of the hot water supply circuit inside the container (1) for the water of the hot water supply circuit, furthermore, the at least one electric heater (3) of the heat-carrying agent of the warming circuit is fully isolated by the inner walls (6) of the container (2) of the warming circuit from a contact with the water of the hot water supply circuit that is disposed inside the container (1) of the hot water supply circuit, wherein the outlet duct (8) for drain of the heat-carrying agent from the container (2) of the warming circuit and the inlet duct (9) for supplying the heat-carrying agent into the container (2) of the warming circuit are sealably mounted and secured in technological openings of the outer wall (7) of the container (2) of the warming circuit, and their end openings are sealably coupled to the corresponding technological openings of the container (2) of the warming circuit inside the container (1) of the hot water supply circuit, and an outlet duct (10) for drain of the water from the container (1) of the hot water supply circuit and an inlet duct (11) for supplying the water into the container (1) of the hot water supply circuit are sealably mounted and secured in the corresponding technological openings of one of the walls of the container (1) of the hot water supply circuit such that their end openings are disposed inside the container (1) of the hot water supply circuit and areas of these outlet (10) and inlet (11) ducts, which are disposed inside the container (1) for the water of the hot water supply circuit, are fully isolated by the inner walls (6) of the container (2) of the heat-carrying agent of the warming circuit from a contact with the heat-carrying agent in the container (2) of the warming circuit, furthermore, inside the container (2) of the warming circuit, there is mounted a temperature sensor (12) for the heat-carrying agent in the container (2) of the warming circuit such that this temperature sensor (12) is fully isolated by the inner walls (6) of the container (2) from a contact with the water in the container (1) of the hot water supply circuit, and inside the container (1) of the hot water supply circuit, there is mounted a temperature sensor (13) for the water in the container (1) such that this temperature sensor (13) is fully isolated by the inner walls (6) of the container (2) for the heat-carrying agent of the warming circuit from a contact with the heat-carrying agent in the container (2) of the warming circuit, furthermore, the at least one electric heater (27) for the water of the hot water supply circuit is mounted and sealably secured in the corresponding technological opening of one of the walls of the container (1) for the water of the hot water supply circuit in such a way that heating sections of the electric heater (27) are disposed inside the container (1) of the hot water supply circuit and are fully isolated by the inner walls (6) of the container (2) for the heat-carrying agent of the warming circuit from a contact with the heat-carrying agent in the container (2) of the warming circuit.

3. The double-circuit electric boiler according to claim 1 or claim 2, characterized in that heat exchange ribs (14) are disposed on outer surfaces of the inner walls (6) of the container (2) of the heat-carrying agent of the warming circuit.

4. The double-circuit electric boiler according to claim 1 or claim 2 or claim 3, characterized in that the outer wall (7) of the container (2) for the heat-carrying agent of the warming circuit is made in the form of a flange (15) that is a bottom of the container (2) for the heat-carrying agent of the warming circuit and that is connected to the inner walls (6) in the lower portion of the container (2) for the heat-carrying agent of the warming circuit, wherein the outer wall (7) in a form of the flange (15) is configured to be sealably secured to one of the walls of the container (1) of the hot water supply circuit.

5. The double-circuit electric boiler according to claim 1 or claim 2 or claim 3 or claim 4, characterized in that the at least one electric heater (3) for the water-carrying agent of the warming circuit is mounted and fixed to an additional flange (17) that is, in turn, mounted and sealably secured in a corresponding technological opening of the outer wall (7) of the container (2) of the warming circuit or the electric heater (3) of the heat-carrying agent of the warming circuit is mounted and sealably secured in the corresponding technological opening of the outer wall (7) that is made in the form of the flange (15) that is a bottom of the container (2) for the heat-carrying agent of the warming circuit.

6. The double-circuit electric boiler according to claim 1 or claim 2 or claim 3 or claim 4 or claim 5, characterized in that the boiler comprises at least one additional electric heater (18) of the heat-carrying agent of the warming circuit that is mounted and sealably secured in the corresponding technological opening of the outer wall (7) of the container (2) for the heat-carrying agent of the warming circuit or is mounted and secured to the additional flange (17) that is, in turn, mounted and sealably secured in the corresponding technological opening of the outer wall (7) of the container (2) for the heat-carrying agent of the warming circuit or in the technological opening of the outer wall (7) that is made in the form of flange (15) that is the bottom of the container (2) for the heat-carrying agent of the warming circuit.

7. The double-circuit electric boiler according to claim 5 or claim 6, characterized in that the temperature sensor (12) for the heat-carrying agent in the container (2) of the warming circuit is mounted and sealably secured to the additional flange (17).

8. The double-circuit electric boiler according to claim 1 or claim 2 or claim 3 or claim 4 or claim 5 or claim 6 or claim 7, characterized in that it further comprises a flow monitoring sensor (19) for the heat-carrying agent of the warming circuit, a pump (20) of the warming circuit and a safety valve (21) of the warming circuit, which are mounted on an outlet pipe (22) of the warming circuit that is, in turn, coupled to the outlet duct (8) for drain of the heat-carrying agent from the container (2) of the warming circuit.

9. The double-circuit electric boiler according to claim 8, characterized in that an expansion tank (23) is connected to the outlet pipe (22) of the warming circuit.

10. The double-circuit electric boiler according to any one of claims 1-9, characterized in that the boiler control elements are made in a form of an electronic system that comprises a controller (25), and this electronic system is assembled on a control panel (26) that is secured on a wall of the boiler housing (5), and a power supply and also the at least one electric heater (3) for the heat-carrying agent of the warming circuit, the temperature sensor (12) for the heat-carrying agent of the warming circuit, and the temperature sensor (13) for the water in the container (1) of the hot water supply circuit are coupled to the control panel (26).

11. The double-circuit electric boiler according to claim 8, characterized in that the boiler control elements are made in a form of an electronic system that comprises a controller (25), and this electronic system is assembled on a control panel (26) that is secured on a wall of the boiler housing (5), and a power supply and also the at least one electric heater (3) for the heat-carrying agent of the warming circuit, the temperature sensor (12) for the heat-carrying agent of the warming circuit, the temperature sensor (13) for the water in the container (1) of the hot water supply circuit, the flow control sensor (19) for the liquid heat-carrying agent of the warming circuit and the warming circuit pump (20) are coupled to the control panel (26).

12. The double-circuit electric boiler according to claim 6, characterized in that the boiler control elements are made in a form of an electronic system that comprises a controller (25), and this electronic system is assembled on a control panel (26) that is secured on a wall of the boiler housing (5), and a power supply and also the at least one electric heater (3) and the at least one additional electric heater (18) of the warming circuit for the heat-carrying agent of the warming circuit, the temperature sensor (12) for the heat-carrying agent of the warming circuit, the temperature sensor (13) for the water in the container (1) of the hot water supply circuit are coupled to the control panel (26).

13. The double-circuit electric boiler according to claim 8, characterized in that the boiler control elements are made in a form of an electronic system that comprises a controller (25), and this electronic system is assembled on a control panel (26) that is secured on a wall of the boiler housing (5), and a power supply and also the at least one electric heater (3) and at least one additional electric heater (18) of the warming circuit for the heat-carrying agent of the warming circuit, the temperature sensor (12) for the heat-carrying agent of the warming circuit, the temperature sensor (13) for the water in the container (1) of the hot water supply circuit, the flow control sensor (19) for the liquid heat-carrying agent of the warming circuit and the warming circuit pump (20) are coupled to the control panel (26).

14. The double-circuit electric boiler according to claim 2, characterized in that the at least one electric heater (27) for the water in the container (1) of the hot water supply circuit is mounted and secured to a flange (28) that is, in turn, mounted and sealably secured in the corresponding technological opening of one of the outer walls of the container (1) of the hot water supply circuit.

15. The double-circuit electric boiler according to claim 14, characterized in that the temperature sensor (13) for the water in the container (1) of the hot water supply circuit is mounted and secured to the flange (28) of the electric heater (27) for the water in the container (1) of the hot water supply circuit.

16. The double-circuit electric boiler according to claim 10 or claim 11 or claim 12 or claim 13 or claim 15, characterized in that the at least one electric heater (27) for the water in the container (1) of the hot water supply circuit is coupled to the control panel (26).

1. A portable, hand-held, standalone guard device (1) with active warning means, the device comprises a housing (2) with a front panel (6), surveillance and event fixation means in a form of an infrared (17) and a radio-frequency (18) intrusion sensor, a motion/movement fixation module (12) with a video camera (13), the module is mounted on the front panel (6), a microphone (11), a starter unit (14) in a form of a power-up button (15) and light-emitting diode indicators (16), power supply means in a form of a main power and recharging unit (19) and a standalone power supply unit (20) with batteries (21), communication means in a form of a WiFi module (34) with a WiFi antenna (35), a GSM module (36) with a GSM antenna (37), active warning means in a form of a lighting warning means (28), a low-frequency (26) and a high-frequency (27) alarm (being acoustic warning means), a gas warning means (33), a wireless reader (41) of cards and ISO/IEC 14443 standards' tags and a wireless keys reading antenna (42), MOSFET power keys (59) of a system for controlling the active warning means (26), (27), (28), (33), a microprocessor module (44) with a main memory unit (45) and with a software that is configured to control the operation of the device (1) at least in a “standby” mode and in an “automatic warning mode” through the MOSFET power keys (59) of the system for controlling the active warning means (26), (27), (28), (33), wherein the microprocessor module (44) is interconnected to and has channels for exchanging signals, data, information with the starter unit (14), with the infrared (17), and with the radio-frequency (18) intrusion sensors, with the wireless reader (41) of cards and ISO/IEC 14443 standards' tags, and the microprocessor module (44) by means of the communication means in the form of the WiFi module (34) and the GSM module (36) is interconnected to and has channels for exchanging signals, data, information with an external software that is located in a wide area network and in local area networks, characterized in that the housing (2) is made in a form of a structural base of the device (1) and comprises a protective envelope (3) with walls (4), a first (8) and a second (9) internal frame elements which are removable form the protective envelope (3) and insertable into the protective envelope (3), a removable rear panel (5) having an internal plane which a main control board with the microprocessor module (44) is secured to, and the removable front panel (6) with a removable protective cap (7), wherein the first internal frame element (8) is a base for securing other structural elements, and the second internal frame element (9) is a housing for the gas or an aerosol, or gas-aerosol warning means (33), furthermore, a display (10) is
